(19) United States
(12) Patent Application Publication
(10) Pub. No.: US 2026/0313064 A1
(43) Pub. Date: Oct. 8, 2026

(54) STORAGE MEDIUM STORING PROGRAM THAT EXTENDS FUNCTIONS OF GENERAL PURPOSE SCAN SOFTWARE CAPABLE OF BEING USED IN COMMON FOR READING APPARATUSES PROVIDED BY A PLURALITY OF MANUFACTURERS, INFORMATION PROCESSING APPARATUS, AND CONTROL METHOD FOR INFORMATION PROCESSING APPARATUS

(71) Applicant: CANON KABUSHIKI KAISHA, Tokyo (JP)

(72) Inventor: SOICHIRO YOSHIGI, Tokyo (JP)

(21) Appl. No.: 19/574,532

(22) Filed: Mar. 23, 2026

(30) Foreign Application Priority Data
Apr. 7, 2025 (JP) 2025-063059

(51) Int. Cl. H04N 1/54

(52) U.S. Cl. CPC H04N 1/54

(57) ABSTRACT

A mechanism that allows a user to use the color conversion function based on the scanner model-specific characteristic difference is provided. A non-transitory computer-readable storage medium stores a program that extends functions of general purpose scan software capable of being used in common for reading apparatuses provided by a plurality of manufacturers. The program causes an information processing apparatus to perform a step of causing a display unit of the information processing apparatus to display a display screen that accepts a setting for a color conversion processing based on a scanner model-specific characteristic difference, with respect to a read image that has been generated by a designated reading apparatus, and a step of causing the information processing apparatus to execute the color conversion processing with respect to the read image that has been generated by the reading apparatus, based on the setting that has been accepted on the display screen.

### BACKGROUND

### Field of the Technology

The present disclosure relates to a storage medium storing a program, an information processing apparatus, a control method for the information processing apparatus.

### Description of the Related Art

There has been known a configuration in which a scan driver, which has been installed on a host computer as control software for controlling a scan apparatus, is used to issue a reading instruction to the scan apparatus that has been connected to the host computer. An operating system (hereinafter, referred to as “an OS”), which is basic software, has been installed on the host computer, and the scan driver is configured in accordance with the specifications defined by the OS and operates (runs) by being invoked from the OS. A vendor (a manufacturer) that provides a scan apparatus is able to provide a scan driver that conforms to the specifications of an OS, thereby providing a means for instructing the scan apparatus to perform reading (scanning) by using the OS.

In recent years, Windows (registered trademark) has been trying to provide a standard class driver (hereinafter, also referred to as “a standard driver”) that is capable of being used in common for scan apparatuses provided by a plurality of vendors. Such a standard driver is included in a package of the OS (has been bundled with the package of the OS), and becomes capable of being easily used by connecting any scan apparatus to the host computer. As a result, there is no need to separately install a model-specific scan driver suitable for the scan apparatus, which is highly convenient. In addition, the standard driver is assumed to be configured to be capable of designating a scan function in accordance with scan function information that has been generated based on information obtained from the scan apparatus connected to the host computer. As a result, a user who uses the standard driver is able to designate a scan function in accordance with capabilities of the scan apparatus connected to the host computer, even though the user uses only one standard driver. However, since the scan function capable of being designated by the user is limited to functions that are capable of being realized only with the standard driver, scanner-vendor-specific functions are not capable of being designated by the user. As a related technique, a technique disclosed in Japanese Laid-Open Patent Publication (kokai) No. 2021-033526 has been proposed. Japanese Laid-Open Patent Publication (kokai) No. 2021-033526 discloses a program that extends print functions of general purpose software.

Here, the scanner-vendor-specific scan driver functions include a color conversion function that is based on a characteristic difference specific to the model of a scanner (hereinafter, simply referred to as “a color conversion function based on a scanner model-specific characteristic difference”). The color conversion function based on the scanner model-specific characteristic difference is a function that performs a color conversion with respect to an image read by a scanner from a color space of the scanner into a different color space desired by the user. The color conversion function based on the scanner model-specific characteristic difference makes it possible to realize, for example, a user request that displays an image of a document read (scanned) by the scanner on a monitor in color tones close to those of the document, and a user request that color-converts the image of the document read (scanned) by the scanner into an image that conforms to a standard color space such as Standard RGB (sRGB) or Adobe RGB.

However, in the case of using the standard driver, the user is not able to use the color conversion function based on the scanner model-specific characteristic difference.

### SUMMARY

The present disclosure provides a mechanism that allows a user to use the color conversion function based on the scanner model-specific characteristic difference.

Accordingly, a first aspect of the present disclosure provides a non-transitory computer-readable storage medium storing a program that extends functions of general purpose scan software capable of being used in common for reading apparatuses provided by a plurality of manufacturers, the program causing an information processing apparatus to perform a step of causing a display unit of the information processing apparatus to display a display screen that accepts a setting for a color conversion processing based on a scanner model-specific characteristic difference, with respect to a read image that has been generated by a designated reading apparatus, and a step of causing the information processing apparatus to execute the color conversion processing with respect to the read image that has been generated by the reading apparatus, based on the setting that has been accepted on the display screen.

Accordingly, a second aspect of the present disclosure provides an information processing apparatus comprising general purpose scan software capable of being used in common for reading apparatuses provided by a plurality of manufacturers and a program that extends functions of the general purpose scan software, the information processing apparatus comprising at least one processor, and a memory coupled to the processor storing the program that, when executed by the processor, causes the processor to display a display screen that accepts a setting for a color conversion processing based on a scanner model-specific characteristic difference, with respect to a read image that has been generated by a designated reading apparatus, and execute the color conversion processing with respect to the read image that has been generated by the reading apparatus, based on the setting that has been accepted on the display screen.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that schematically illustrates a hardware configuration of a scan system that includes a host computer as an information processing apparatus according to an embodiment of the present disclosure.

FIGS. 2A and 2B are block diagrams that each schematically illustrate a software configurations of the host computer shown in FIG. 1.

FIGS. 3A, 3B, and 3C, are diagrams that illustrate examples of screens displayed on a display unit shown in FIG. 1.

FIG. 4 is a flowchart that illustrates the procedure of an editing processing of scan function information, which is executed by a scan function extending unit shown in FIG. 2B.

FIGS. 5A, 5B, and 5C, are diagrams that illustrate examples of various information used in the scan system shown in FIG. 1.

FIG. 6 is a sequence diagram that illustrates the procedure of a scan control processing executed in the scan system shown in FIG. 1.

FIG. 7 is a flowchart that illustrates the procedure of a scan instruction command generation processing executed by an extension application shown in FIG. 2B.

FIG. 8 is a flowchart that illustrates the procedure of a scan processing performed in S616 of FIG. 6.

FIGS. 9A and 9B are diagrams for explaining a color conversion processing using two types of ICC profiles in the embodiment of the present disclosure.

FIG. 10 is a diagram that illustrates an example of an LUT used by the host computer shown in FIG. 1.

FIGS. 11A, 11B, and 11C, are diagrams that illustrate examples of a detailed setting screen including upload buttons.

FIG. 12 is a diagram that illustrates an example of a detailed setting screen including a preview image.

FIG. 13 is a diagram for explaining a configuration in which a scan apparatus performs a part of the color conversion processing using the two types of ICC profiles.

### DESCRIPTION OF THE EMBODIMENTS

The present disclosure will now be described in detail below with reference to the accompanying drawings showing embodiments thereof.

Hereinafter, an embodiment of the present disclosure will be described in detail with reference to the accompanying drawings. It should be noted that the following embodiment does not limit the present disclosure as defined by the claims, and not all of the combinations of features described in the following embodiment are necessarily essential to the solving means of the present disclosure. It should be noted that the same components are given the same reference numerals and their descriptions are omitted.

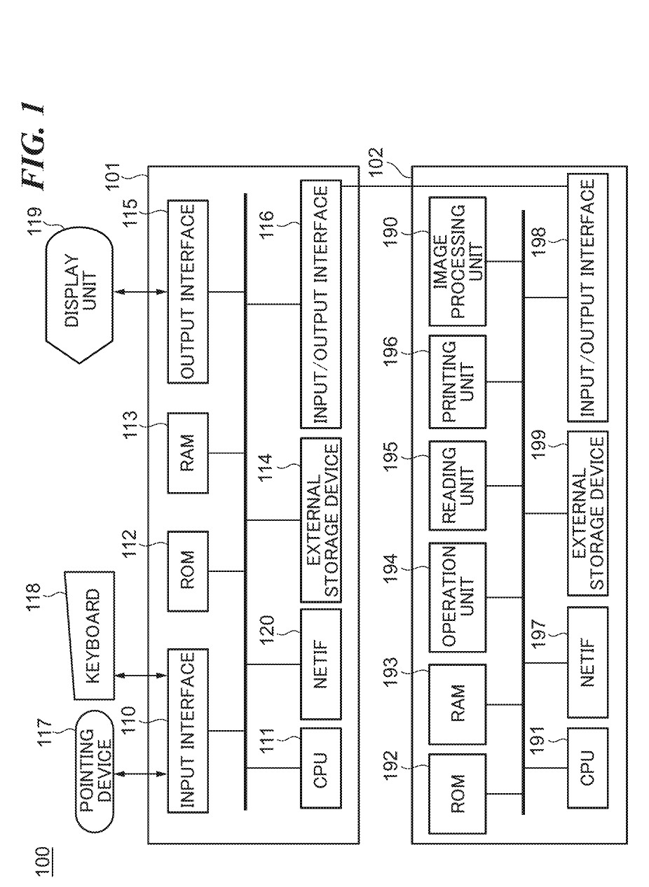

FIG. 1 is a block diagram that schematically illustrates a hardware configuration of a scan system 100 that includes a host computer 101 as an information processing apparatus according to the embodiment of the present disclosure.

As shown in FIG. 1, the scan system 100 is configured to include the host computer 101 and a scan apparatus 102.

The host computer 101 is an example of the information processing apparatus, and includes an input interface 110, a central processing unit (a CPU) 111, a read only memory (a ROM) 112, a random access memory (a RAM) 113, an external storage device 114, an output interface 115, an input/output interface 116, and a NETIF 120. Input devices such as a keyboard 118 and a pointing device 117 are connected to the input interface 110, and a display device such as a display unit 119 is connected to the output interface 115. The NETIF 120 is a network interface, and performs control for performing data transfer with an external device via a network.

The ROM 112 stores an initialization program. The external storage device 114 is, for example, a hard disk drive (an HDD) or a solid state drive (an SSD). The external storage device 114 stores an application program group (a group of application programs), an operating system (an OS), and other various kinds of data. The RAM 113 is used as a working memory or the like when executing various kinds of programs that have been stored in the external storage device 114, and the various kinds of programs become able to run within the host computer 101.

It should be noted that in the present embodiment, the CPU 111 performs processing in accordance with codes of the programs that have been stored in the ROM 112, thereby executing functions of the host computer 101, which will be described below, and processing of the host computer 101 according to flowcharts, which will be described below.

The scan apparatus 102 is an example of a reading apparatus, and is connected to the host computer 101 via an input/output interface 198 of the scan apparatus 102 and the input/output interface 116 of the host computer 101. The input/output interface 198 of the scan apparatus 102 and the input/output interface 116 of the host computer 101 may be connected to each other via a wired network or a wireless network.

The scan apparatus 102 includes a CPU 191, a ROM 192, a RAM 193, an operation unit 194, a reading unit 195, a printing unit 196, a NETIF 197, an image processing unit 190, an external storage device 199, and the input/output interface 198.

The CPU 191 comprehensively controls the scan apparatus 102. The ROM 192 is a memory that stores programs. The RAM 193 is a memory that temporarily stores programs and image data. The reading unit 195 is a scanner, and reads an image of a document. The printing unit 196 prints an image on a sheet based on image data. It should be noted that the printing unit 196 is not essential. The NETIF 197 is a network interface, and performs control for performing data transfer with an external device via the network. The image processing unit 190 performs various kinds of image editing processing with respect to the inputted image data.

As shown in FIG. 1, in the present embodiment, although the host computer 101 and the scan apparatus 102 are configured as separate apparatuses, the host computer 101 and the scan apparatus 102 may be configured as a single information processing apparatus. In addition, a scan setting screen and a detailed setting screen, which will be described below, are displayed on the display unit 119. It should be noted that in the present embodiment, the scan apparatus 102 will be described as an electrophotographic digital multifunction peripheral (an electrophotographic digital MFP) that has a plurality of functions such as copying, printing, and faxing. However, the present disclosure is not limited to the scan apparatus 102 being an electrophotographic digital MFP, and the present disclosure is also capable of being applied to an apparatus that uses another process such as an inkjet system, or a scanner that only performs reading an image. In addition, the host computer 101 may be a desktop type personal computer, a smartphone, or a notebook type personal computer.

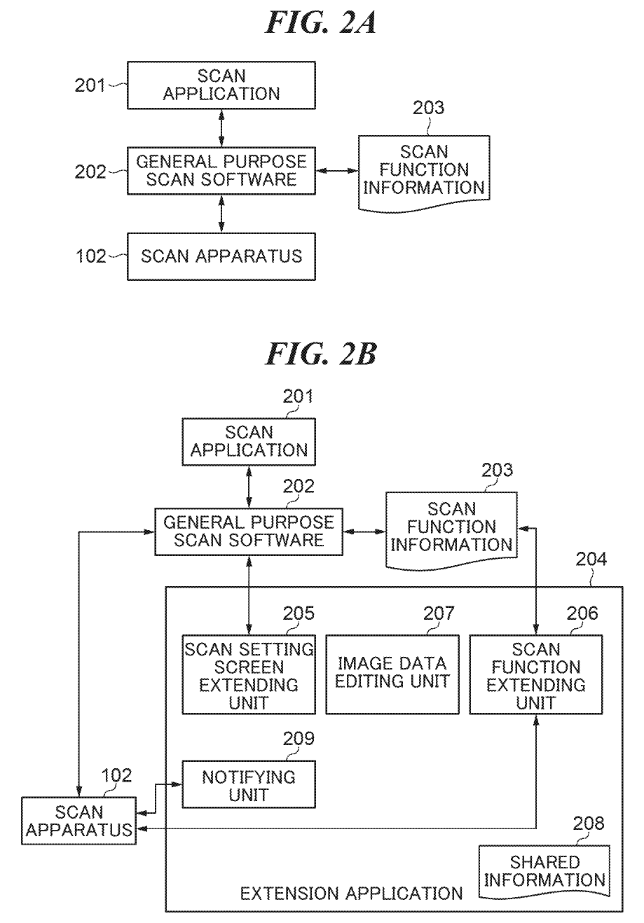

FIGS. 2A and 2B are block diagrams that each schematically illustrate a software configurations of the host computer 101 shown in FIG. 1. Programs for causing to execute software modules that are shown in FIGS. 2A and 2B have been stored in the external storage device 114 shown in FIG. 1. Here, the description is based on the premise that the host computer 101 is configured to be equipped with Windows (registered trademark) 11 by Microsoft (registered trademark) as its operating system. FIG. 2A is a diagram that illustrates a general software configuration in the case where an extension application 204 has not been associated with general purpose scan software 202 and the scan apparatus 102. Furthermore, FIG. 2B is a diagram that illustrates a software configuration in the case where the extension application 204 has been associated with the general purpose scan software 202 and the scan apparatus 102.

First, the software configuration of the host computer 101 in the case where the extension application 204 has not been associated will be described with reference to FIG. 2A.

A scan application 201 is software that imports a scanned content (scanned image data), and examples of the scan application 201 include a document creation application and an image editing application. When the scan application 201 receives a scan request from a user, the scan application 201 issues a scan instruction to the OS of the host computer 101. The scan instruction includes scan setting information for instructing the operations of the general purpose scan software 202 and the scan apparatus 102.

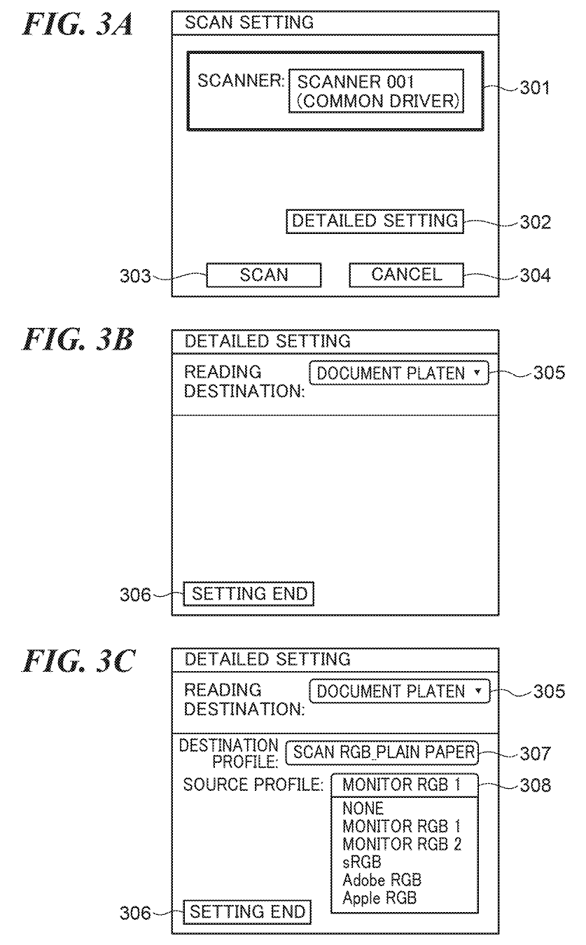

In order to execute the scan instruction, the scan application 201 is able to cause to display a scan setting screen that is provided by any one of the general purpose scan software 202, the OS, and the scan application 201. In addition, when a detailed setting button on the scan setting screen is pressed, the general purpose scan software 202 additionally displays a detailed setting screen. It should be noted that the scan setting screen and the detailed setting screen will be described below with reference to FIGS. 3A, 3B, and 3C. In accordance with capability information (settable information) of the general purpose scan software 202, the detailed setting screen includes setting items (hereinafter, also referred to as “control items”) indicating settable scan functions and control items indicating setting values thereof. The general purpose scan software 202 decides scanning capabilities based on scan function information 203. The scan function information 203 is data indicating all settable scan functions, setting values of the all settable scan functions, and scan functions in which exclusive relationships between the setting values have been described. The scan function information 203 is included in a configuration file of the general purpose scan software 202 and is stored in the external storage device 114 as an unchangeable file. Alternatively, the scan function information 203 is capable of being dynamically generated by the general purpose scan software 202. Specifically, the general purpose scan software 202 or the OS is capable of being configured to obtain attribute data of the scan apparatus 102 from the scan apparatus 102 and generate the scan function information 203 in accordance with attribute information within the obtained attribute data. It should be noted that in the case where the scan function information 203 is dynamically generated, it is possible to perform editing with respect to the scan function information 203 that has been generated. In addition, the attribute data of the scan apparatus 102 obtained from the scan apparatus 102 includes attribute information indicating functions that are capable of being designated in the scan apparatus 102 (attribute information indicating the capabilities of the scan apparatus 102) and setting values related to the attribute information, which are stored in the RAM 113.

With such a configuration, the general purpose scan software 202 is capable of being configured to allow the user to designate scan functions that are capable of being used in the scan apparatus 102, depending on the scan apparatus 102 connected to the host computer 101. In other words, even in the case where a scan apparatus with different functions or a scan apparatus developed by a different vendor is connected to the host computer 101, the general purpose scan software 202 is capable of being configured to allow the user to designate scan functions that are capable of being used (available scan functions), depending on the scan apparatus with different functions or the scan apparatus developed by a different vendor that has been connected to the host computer 101. It should be noted that the vendor may be the manufacturer of the scan apparatus 102. It should be noted that here, the general purpose scan software 202 is a standard class driver that executes scanning based on a standard scan protocol called Mopria. The general purpose scan software 202 obtains the capability information of the scan apparatus 102 connected to the host computer 101 and generates the scan function information 203 based on the capability information of the scan apparatus 102 that has been obtained so that the user is able to designate scan function(s) supported by the scan apparatus 102 connected to the host computer 101. However, the general purpose scan software 202 does not support a color conversion function based on the scanner model-specific characteristic difference. This is because the color conversion function based on the scanner model-specific characteristic difference is a scanner-vendor specific function (a scanner-manufacturer specific function).

The color conversion function based on the scanner model-specific characteristic difference is a function that performs a color conversion with respect to an image read by a scanner from a color space of the scanner into a different color space desired by the user. With the color conversion function based on the scanner model-specific characteristic difference, it is possible to display an image of a document read (scanned) by the scanner on a monitor in color tones close to those of the document, and to obtain a scanned image (a read image) in a standard color space.

Here, the color conversion function based on the scanner model-specific characteristic difference will be described. In the present embodiment, as an example, a configuration in which two types of ICC profiles are used for the color conversion function based on the scanner model-specific characteristic difference will be described. It should be noted that ICC is an abbreviation for International Color Consortium. An ICC profile is data that manages information that associates a device-dependent color space with a device-independent absolute color space (a Profile Connection Space, hereinafter referred to as “a PCS”). Examples of the PCS include an L*a*b* color space and an XYZ color space, and the PCS is a device-independent color space that basically includes all colors that are capable of being perceived by humans (all human-perceivable colors). In the present embodiment, the two types of ICC profiles to be used are referred to as a destination profile and a source profile, respectively.

The destination profile is an ICC profile for converting from a device-dependent color space into the PCS. For example, an ICC profile that converts from a RGB color space of the scanner into the XYZ color space, which is the PCS, is the destination profile. By using the destination profile, it is possible to convert RGB signal values of the image read by the scanner into XYZ values as absolute colors.

The source profile is an ICC profile for converting from the PCS into a device-dependent color space. For example, an ICC profile that converts from the XYZ color space into a RGB color space used by a monitor is the source profile. By using the source profile, for example, in the case of wanting to display XYZ values of a certain absolute color on a monitor, it is possible to know which RGB signal values should be converted into. In addition, as described above, the ICC profiles often include device-dependent conversion methods, and in such cases, the ICC profiles are generally provided by the respective device manufacturers.

Next, a processing example of the color conversion function based on the scanner model-specific characteristic difference, in which the above-described two types of ICC profiles are used, will be described. As an example, a processing for matching color tones of a document with color tones of a scanned image (a read image) of the document displayed on a monitor will be described.

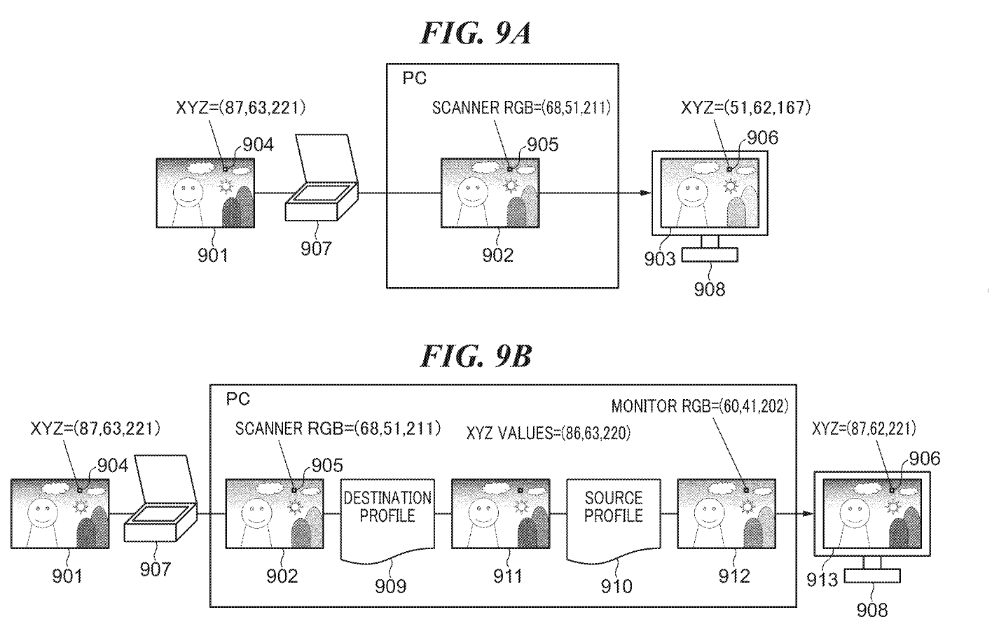

In the case of displaying 8-bit RGB signal values of an image obtained by reading (scanning) a document with a scanner on a monitor, there is a very high possibility that color tones of the document and color tones of the monitor will not match. As an example of the case where color tones of the document and color tones of the monitor do not match, FIG. 9A shows a processing flow in the case of directly displaying RGB signal values of an image (a scanned image) obtained by reading (scanning) with a scanner 907 as RGB signal values on a monitor 908. A reference numeral 901 denotes a document, a reference numeral 902 denotes an image obtained by reading (scanning) the document 901 with the scanner 907, and a reference numeral 903 denotes an image obtained by displaying, on the monitor 908, the image 902 obtained by reading (scanning) with the scanner 907. However, since the image 902 obtained by reading (scanning) the document 901 with the scanner 907 is actually data that is handled only within the computer, it is not possible to visually confirm color tones of the image 902. Therefore, the image 902 shown in FIG. 9A is an image just as an image for illustrative purposes. Here, a change in color information of a certain point 904 on the document 901 will be described. The color of the point 904 on the document 901 is capable of being expressed in the XYZ color space, which is the device-independent absolute color space that has been described. FIG. 9A shows an example in which XYZ values of the point 904 on the document 901 are (87, 63, 221).

The scanner 907 reads (scans) the document 901 and outputs the image 902 in a RGB color space of the scanner 907. Here, it is assumed that RGB signal values of a point 905 in the image 902, which is located at a position corresponding to the point 904 on the document 901, are (68, 51, 211). The RGB signal values output by the scanner 907 are affected by the characteristics of the scanner 907. In other words, the RGB signal values output by the scanner that reads (scans) the document 901 are different.

In addition, the monitor 908 maps the RGB signal values of the image 902 directly to an original RGB color gamut of the monitor 908, and displays the image 902 output by the scanner 907. It is assumed that XYZ values of a point 906 on the monitor 908, which is located at a position corresponding to the point 905 in the image 902, are (51, 62, 167). Since the XYZ values of the document 901 are (87, 63, 221), in FIG. 9A, the color tones of the document 901 and the color tones of the monitor 908 do not match. When the monitor 908 displays colors on the monitor 908 based on the RGB signal values, the monitor 908 does not take into consideration the RGB color space of the scanner 907, and as a result, the colors are displayed on the monitor 908 in color tones different from the color tones of the document 901.

Next, a processing for matching the color tones of the document and the color tones of the monitor by using the above-described two types of ICC profiles will be described. FIG. 9B shows the flow of the processing for matching the color tones of the document and the color tones of the monitor by using the above-described two types of ICC profiles. FIG. 9B differs from FIG. 9A in two respects. The first respect is that a personal computer (a PC) connected to the monitor 908 color-converts the image 902 obtained by reading with the scanner 907 by using a destination profile 909 to generate an image 911 in the PCS (in the XYZ color space). The second respect is that the PC connected to the monitor 908 color-converts the image 911 in the PCS that has been generated by using a source profile 910 to generate an image 912 in the RGB color space of the monitor 908. In addition, as described above, since the image 912 in the RGB color space of the monitor 908 is actually data that is handled only within the computer, it is not possible to visually confirm color tones of the image 912. Therefore, the image 912 shown in FIG. 9B is an image just as an image for illustrative purposes. Other respects other than the two respects described above are the same as those in FIG. 9A, and therefore the description thereof will be omitted.

The destination profile 909 is an ICC profile for converting the RGB color space of the scanner 907 into the PCS (the XYZ color space). When the RGB values of the image 902 obtained by reading with the scanner 907 are converted by the destination profile 909, XYZ values are obtained.

The source profile 910 is an ICC profile for converting from the PCS into the RGB color space of the monitor 908. In order to reproduce the same XYZ values on the monitor 908 as the XYZ values on the PCS (the XYZ color space), the source profile 910 is assumed to be able to know which RGB signal values need to be transmitted to the monitor 908. It should be noted that for the purposes of description, it is assumed that the RGB signal values in the RGB color space and the XYZ values in the PCS both take 8-bit values ranging from 0 to 255, but in reality, both the RGB signal values in the RGB color space and the XYZ values in the PCS are not limited to taking 8-bit values ranging from 0 to 255. In addition, the two types of ICC profiles described above are a combination of ICC profiles used for the purpose of matching the color tones of the document 901 with the color tones of the monitor 908. Therefore, if the purpose is different, it is necessary to select an ICC profile with optimal characteristics to match that purpose. For example, in the case of wanting to cause the monitor 908 to display vivid colors without matching the color tones of the document, it is necessary to select a source profile capable of converting into RGB signal values that make the XYZ values on the monitor 908 more vivid than the XYZ values on the PCS (the XYZ color space).

First, the image 902 output from the scanner 907 is converted from the RGB color space of the scanner 907 into the image 911 in the PCS (in the XYZ color space) by the destination profile 909. It should be noted that a specific color conversion method using the ICC profile will be described below. When the destination profile 909 is used, as described above, the RGB signal values of the image 902 obtained by reading with the scanner 907 are converted into the XYZ values on the PCS that are the same as the XYZ values on the document. However, due to a calculation error or the like during the color conversion using the ICC profile, the XYZ values on the PCS and the XYZ values on the document may not become exactly the same XYZ values. In FIG. 9B, by the color conversion using the destination profile 909, the XYZ values (87, 63, 221) on the document and the XYZ values (86, 63, 220) on the PCS become almost the same values.

Next, the image 911 in the PCS (in the XYZ color space) is converted into the image 912 in the RGB color space of the monitor 908 by the source profile 910. It should be noted that a specific color conversion method using the ICC profile will be described below. When the source profile 910 is used, as described above, the XYZ values on the PCS are converted into the RGB signal values of the monitor 908 that become the same XYZ values when displayed on the monitor 908. In FIG. 9B, it is assumed to be color-converted into (60, 41, 202) as the RGB signal values of the monitor by the source profile 910.

The monitor 908 displays the image 912 in the RGB color space of the monitor, which has been generated by using the source profile 910, on the monitor 908 (for example, see an image 913). In FIG. 9B, it is assumed that the XYZ values displayed on the monitor 908 have become (87, 62, 221). Since the XYZ values in the document 901 are (87, 63, 221), the color conversion using the two types of ICC profiles is performed, making it possible to make the color tones on the monitor 908 closer to the color tones of the document. However, similar to the destination profile 909, due to a calculation error or the like during the color conversion using the ICC profile, the XYZ values displayed on the monitor 908 and the XYZ values in the document 901 may not become exactly the same XYZ values.

Although the example of the color conversion based on the scanner model-specific characteristic difference has been described above, the color conversion based on the scanner model-specific characteristic difference is not limited to the example described above, and any method may be used as long as it is capable of performing a color conversion taking into consideration the scanner model-specific characteristic difference.

Next, the color conversion method using the ICC profile will be described. In FIG. 9B, the color conversion is performed by using the two types of ICC profiles, the destination profile 909 and the source profile 910, but the basic idea of associating a device-dependent color space with a PCS is the same for both the destination profile 909 and the source profile 910. Therefore, here, the color conversion method using the ICC profile will be described by using the destination profile 909 shown in FIG. 9B as an example.

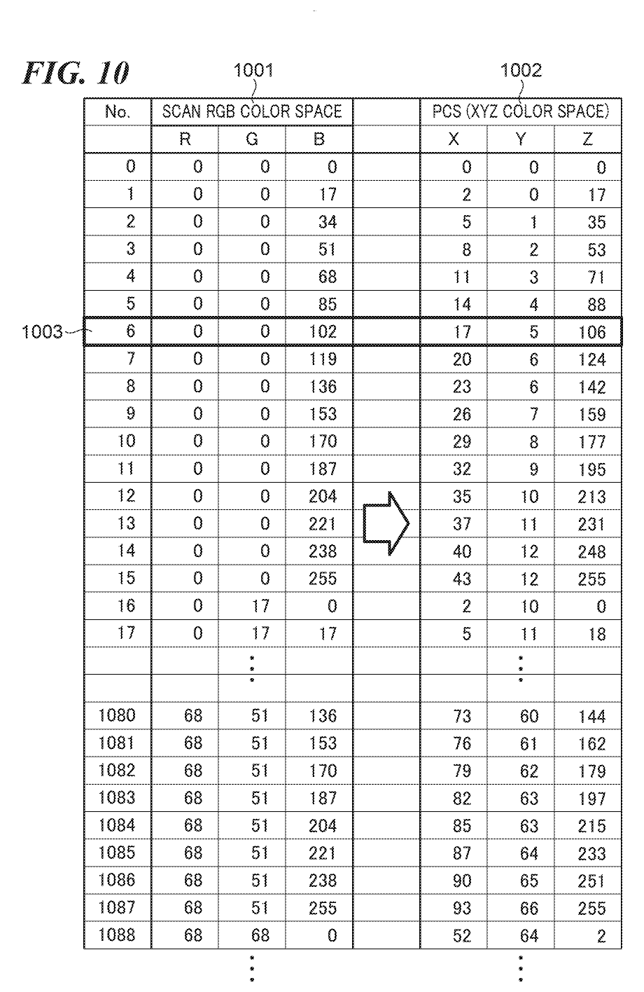

The ICC profile is capable of managing a variety of color conversion methods, including a method of using multidimensional lookup tables (multidimensional LUTs) and a linear conversion method of using matrices. Here, a method using an LUT, which is one of the common color conversion methods, will be described. In the case of the destination profile 909, the RGB signal values of the scanner 907, which are input, are converted into XYZ values in the PCS by referring to an LUT in which scanned RGB values that are input and XYZ values that are output are associated with each other. In this case, by using an interpolation operation such as tetrahedral interpolation, it is possible to thin out the LUT to reduce the table size, or to use any continuous value for the input data. FIG. 10 shows a 16×16×16 LUT that has been created by thinning out, by 17 steps, the 8-bit RGB signal values ranging from 0 to 255. An input 1001 is the color space of the scanner 907, and an output 1002 is the XYZ color space of the PCS. For example, the RGB signal values of the scanner 907, RGB = (0, 0, 102), are converted into XYZ = (17, 5, 106) in the XYZ color space of the PCS by using information 1003 of the LUT shown in FIG. 10. In addition, even in the case where RGB = (68, 51, 211) shown as an example in FIG. 9B, which are not included in the input 1001 of the LUT shown in FIG. 10, are input, RGB = (68, 51, 211) are capable of being converted into values such as XYZ = (86, 63, 220) by, for example, using the tetrahedral interpolation.

In the present embodiment, by installing the extension application 204 on the host computer 101, it becomes possible to use the color conversion function based on the scanner model-specific characteristic difference that has been described above.

Next, the software configuration of the host computer 101 in the case where the extension application 204 has been associated will be described with reference to FIG. 2B. It should be noted that configurations and processes that are not specifically described below are the same as those in FIG. 2A.

The extension application 204 is software for extending the functions of the general purpose scan software 202, and is software that is not included in advance in the OS (that is not bundled with the OS). Therefore, the user needs to operate the host computer 101 to download the extension application 204 from a server (not shown) via the Internet and install the extension application 204 on the host computer 101. Alternatively, the extension application 204 may be automatically installed on the host computer 101 based on the connection of the scan apparatus 102 to the host computer 101. Specifically, in the case where the scan apparatus 102 is connected to the host computer 101, the OS of the host computer 101 obtains device identification information from the scan apparatus 102. The OS of the host computer 101 may download the extension application 204 corresponding to the obtained device identification information from the server via the Internet and then install the extension application 204. In other words, the general purpose scan software 202 and the extension application 204 are retained in the host computer 101 as separate files.

It should be noted that the general purpose scan software 202 and the extension application 204 may be updated and upgraded, but an update processing of the general purpose scan software 202 and an update processing of the extension application 204 are performed at different timings. In other words, the timing at which the host computer 101 obtains the general purpose scan software 202 differs from the timing at which the host computer 101 obtains the extension application 204. In addition, a trigger for the host computer 101 to obtain the general purpose scan software 202 differs from a trigger for the host computer 101 to obtain the extension application 204. It should be noted that in the case where the extension application 204 has been installed on the host computer 101, the OS of the host computer 101 associates the extension application 204 with the general purpose scan software 202 and the scan apparatus 102.

The extension application 204 in the present embodiment includes a scan setting screen extending unit 205, a scan function extending unit 206, an image data editing unit 207, and a notifying unit 209. In addition, the extension application 204 includes shared information 208 that is capable of being commonly accessed from each unit of the scan setting screen extending unit 205, the scan function extending unit 206, the image data editing unit 207, and the notifying unit 209. The shared information 208 is actually a file that has been stored in the external storage device 114 or information that has been stored in the RAM 113. The extension application 204 uses an application program interface (an API) provided by the OS of the host computer 101 to write and read information to and from the shared information 208.

It should be noted that the extension application 204 may terminate its operation each time the processing of one unit of the scan setting screen extending unit 205, the scan function extending unit 206, the image data editing unit 207, and the notifying unit 209 is completed. In this case, the OS of the host computer 101 will start up the extension application 204 every time the OS of the host computer 101 receives a request to use one unit of the scan setting screen extending unit 205, the scan function extending unit 206, the image data editing unit 207, and the notifying unit 209.

Furthermore, the extension application 204 may cancel the processing of one unit of the scan setting screen extending unit 205, the scan function extending unit 206, the image data editing unit 207, and the notifying unit 209 during the processing of one unit of the scan setting screen extending unit 205, the scan function extending unit 206, the image data editing unit 207, and the notifying unit 209. In the case where the processing of one unit of the scan setting screen extending unit 205, the scan function extending unit 206, the image data editing unit 207, and the notifying unit 209 has been canceled, a job being processed is deleted by the OS of the host computer 101.

When the scan application 201 receives a scan request from the user, the scan application 201 issues a scan instruction to the OS of the host computer 101. In the configuration shown in FIG. 2B, similar to the configuration shown in FIG. 2A, the scan application 201 is able to cause to display a scan setting screen. In the configuration shown in FIG. 2B, a detailed setting screen provided by the extension application 204 is displayed. Specifically, a detailed setting screen provided by the scan setting screen extending unit 205 included in the extension application 204 is displayed. In addition, the scan setting screen extending unit 205 is able to save (store), in the shared information 208, a detailed setting that has been set by the user.

The image data editing unit 207 of the extension application 204 obtains image data from the scan apparatus 102 and performs editing with respect to the obtained image data. The image data editing unit 207 obtains detailed setting information (the detailed setting that has been set by the user) from the shared information 208, and performs image editing in accordance with the obtained detailed setting, with respect to the image data. The extension application 204 may be configured to obtain image data that has been obtained by the general purpose scan software 202 and perform image editing in accordance with the detailed setting, with respect to the image data that has been obtained by the general purpose scan software 202. In addition, in the configuration shown in FIG. 2B, there is a case where the setting of the color conversion based on the scanner model-specific characteristic difference is not performed by the user. In this case, as in the configuration shown in FIG. 2A, the general purpose scan software 202 may issue a scan request instruction to the scan apparatus 102 without going through the extension application 204.

The scan function extending unit 206 of the extension application 204 is able to edit the scan function information 203 that has been generated by the general purpose scan software 202 or the OS of the host computer 101. As a result, the scan function extending unit 206 is able to perform the addition of functions provided by the extension application 204. In addition, the scan function extending unit 206 is able to perform the addition of a function that is supported by the scan apparatus 102 but is not supported by the general purpose scan software 202 (the color conversion function based on the scanner model-specific characteristic difference). Furthermore, the scan function extending unit 206 is able to perform the addition of the exclusive relationship between setting values of the scan function, and the like. The OS of the host computer 101 starts up the scan function extending unit 206 when the extension application 204 has been first associated with the scan apparatus 102 and the general purpose scan software 202. Furthermore, the OS of the host computer 101 may start up the scan function extending unit 206 at a timing other than the above timing, for example, a timing when the OS of the host computer 101 is started up.

The notifying unit 209 of the extension application 204 is able to display a notification to the user, in response to the occurrence of an error in the scan apparatus 102. For example, when a reading jam error occurs in the scan apparatus 102, the general purpose scan software 202 detects the occurrence of the reading jam error, and the OS of the host computer 101, by using a notifying function called a toast notification, which is one of the functions of the OS of the host computer 101, causes the display unit 119 to display a message. When the user presses the toast notification, the notifying unit 209 of the extension application 204 is invoked from the OS of the host computer 101, and a user interface screen (a UI screen) of the notifying unit 209 is displayed. It is possible to display, on the UI screen of the notifying unit 209, for example, a detailed message about a scanning jam error (the reading jam error), a method for clearing the jam, etc.

In addition, the configuration of the extension application 204 for realizing the present embodiment is not limited to a configuration that includes all of the functions (the units) that have been described, but may be a configuration that includes only some of the functions (the units) that have been described, or the configuration of the extension application 204 for realizing the present embodiment may also include other function(s). In addition, the extension application 204 is sometimes simply referred to as “scan software”. As described above, the extension application 204 can be said to include at least one of the following functions. The first function is a function to display a setting screen (the scan setting screen extending unit 205). The second function is a function to edit the image data in accordance with the detailed setting (the image data editing unit 207). The third function is a function to extend the functions that are capable of being designated by image data generation software (the scan function extending unit 206). The fourth function is a function to display a screen in response to the occurrence of an error in the scan apparatus 102 (the notifying unit 209).

Next, examples of the scan setting screen and the detailed setting screen in the present embodiment will be described with reference to FIGS. 3A, 3B, and 3C. FIG. 3A illustrates a scan setting screen displayed by the scan application 201. FIG. 3B illustrates a detailed setting screen displayed in the configuration shown in FIG. 2A, that is, a detailed setting screen displayed in the configuration in which the extension application 204 has not been installed on the host computer 101. FIG. 3C illustrates a detailed setting screen displayed in the configuration shown in FIG. 2B, that is, a detailed setting screen displayed in the configuration in which the extension application 204 has been installed on the host computer 101. It should be noted that the unit or the module that displays the scan setting screen is not limited to the above. For example, the scan setting screen extending unit 205 may be configured to only generate a display screen. In this case, the scan setting screen extending unit 205 transmits the generated display screen to the scan application 201 via the general purpose scan software 202, and the scan application 201 displays the obtained display screen.

First, FIG. 3A will be described. A control 301 includes an object for allowing the user to set a scanner that executes reading (scanning) of a document to obtain image data (a scanner to be used for reading (scanning)). A control 303 is a button to start scanning. A control 304 is a button to cancel scanning. A control 302 is a detailed setting button, and when the control 302 is pressed, a detailed setting screen is displayed by the general purpose scan software 202 or the scan setting screen extending unit 205.

Next, FIG. 3B will be described. FIG. 3B illustrates a detailed setting screen displayed by the general purpose scan software 202 in the configuration shown in FIG. 2A, that is, in the configuration in which the extension application 204 has not been installed on the host computer 101. By using a control 305, it is possible to set a reading destination, and in FIG. 3B, as an example, “document platen” has been selected. A control 306 is a setting end button, and when the control 306 is pressed, returning to the scan setting screen shown in FIG. 3A.

Next, FIG. 3C will be described. FIG. 3C illustrates a detailed setting screen displayed by the scan setting screen extending unit 205 in the configuration shown in FIG. 2B, that is, in the configuration in which the extension application 204 has been installed on the host computer 101. The detailed setting screen shown in FIG. 3C is different from the detailed setting screen shown in FIG. 3B, and the detailed setting screen shown in FIG. 3C includes a pull-down 307 for selecting a destination profile and a pull-down 308 for selecting a source profile.

As described above, the destination profile is an ICC profile that converts from the RGB color space of the scanning into the PCS. The user is able to operate the pull-down 307 to select one destination profile from among a plurality of destination profiles. In the present embodiment, as an example, the pull-down 307 is capable of displaying “Scan RGB_Plain Paper”, “Scan RGB_Coated Paper”, “Scan RGB_Matte Coated Paper”, and “Scan RGB_Recycled Paper”. In addition, it is possible to select one destination profile to be used from among these. In FIG. 3C, as an example, “Scan RGB_Plain Paper” has been selected.

“Scan RGB_Plain Paper” is an ICC profile that is based on the RGB color space of the scanner, and converts from the RGB color space of the scanner into the PCS (the XYZ color space) so that the XYZ values on the converted PCS (the converted XYZ color space) are the same as the XYZ values on the document. “Scan RGB_Coated Paper” is a destination profile created for coated paper. “Scan RGB_Matte Coated Paper” is a destination profile created for matte coated paper. “Scan RGB_Recycled Paper” is a destination profile created for recycled paper.

In addition, the user is able to operate the pull-down 308 to select one source profile from among a plurality of source profiles. When the user presses the pull-down 308, a list of candidates of the ICC profile selectable as a source profile is displayed. For example, in the case where the file system of the OS has a directory in which source profiles are collected in the ROM 192 or the external storage device 114, the ICC profiles that have been stored in the directory are displayed in a list. In the present embodiment, as an example, it is assumed that five types of source profiles, “Monitor RGB 1”, “Monitor RGB 2”, “sRGB”, “Adobe RGB”, and “Apple RGB”, have been stored in the above directory. In this case, as shown in FIG. 3C, all of these are displayed in a list. It should be noted that in the present embodiment, the configuration has been described in which the above-described five types of source profiles have been stored in the above directory, but source profiles other than the above-described five types of source profiles may also be stored in the above directory. Furthermore, it is not necessary to display all the ICC profiles, which have been stored in the above directory, in a list.

“Monitor RGB 1” is an ICC profile that is based on the RGB color space of the monitor. “Monitor RGB 1” converts the XYZ values on the PCS (the XYZ color space) into RGB signal values that match the XYZ values on the monitor. “Monitor RGB 1” is used, for example, in the case of wanting to match the color tones of the document with the color tones of the monitor.

“Monitor RGB 2” is an ICC profile that is based on the RGB color space of the monitor. “Monitor RGB 2” converts the XYZ values on the PCS (the XYZ color space) into RGB signal values that make the XYZ values on the monitor more vivid than the XYZ values on the PCS (the XYZ color space). “Monitor RGB 2” is used, for example, in the case of wanting to cause the monitor to display vivid colors.

“sRGB” is an ICC profile for converting from the PCS color space into an sRGB color space, which is one of the standard color spaces. “Adobe RGB” is an ICC profile for converting from the PCS color space into an Adobe RGB color space, which is one of the standard color spaces. “Apple RGB” is an ICC profile for converting from the PCS color space into a RGB color space created by Apple.

Here, the reason why the scan setting items are different between FIGS. 3B and 3C will be described. The detailed setting screen is generated by referring to the scanning capabilities that have been generated based on the scan function information. However, since the general purpose scan software 202 does not support the color conversion function based on the scanner model-specific characteristic difference, it is not possible to add, to the scan function information, the color conversion function based on the scanner model-specific characteristic difference. In addition, even in the case where the scan function information originally includes the color conversion function based on the scanner model-specific characteristic difference, the general purpose scan software 202 is not able to interpret the color conversion function based on the scanner model-specific characteristic difference that is included in the scan function information. Therefore, it is not possible to display, on the detailed setting screen, setting items of the color conversion based on the scanner model-specific characteristic difference. Therefore, a configuration is adopted in which the scan function extending unit 206 adds, to the scan function information 203, the color conversion function based on the scanner model-specific characteristic difference, and the scan setting screen extending unit 205 refers to the scanning capabilities and then causes to display the detailed setting screen. With this configuration, the extension application 204 becomes able to cause the detailed setting screen to display the setting items of the color conversion based on the scanner model-specific characteristic difference. It should be noted that the detailed setting screen shown in FIG. 3C may additionally include setting item(s) for extension function(s) other than the color conversion function based on the scanner model-specific characteristic difference.

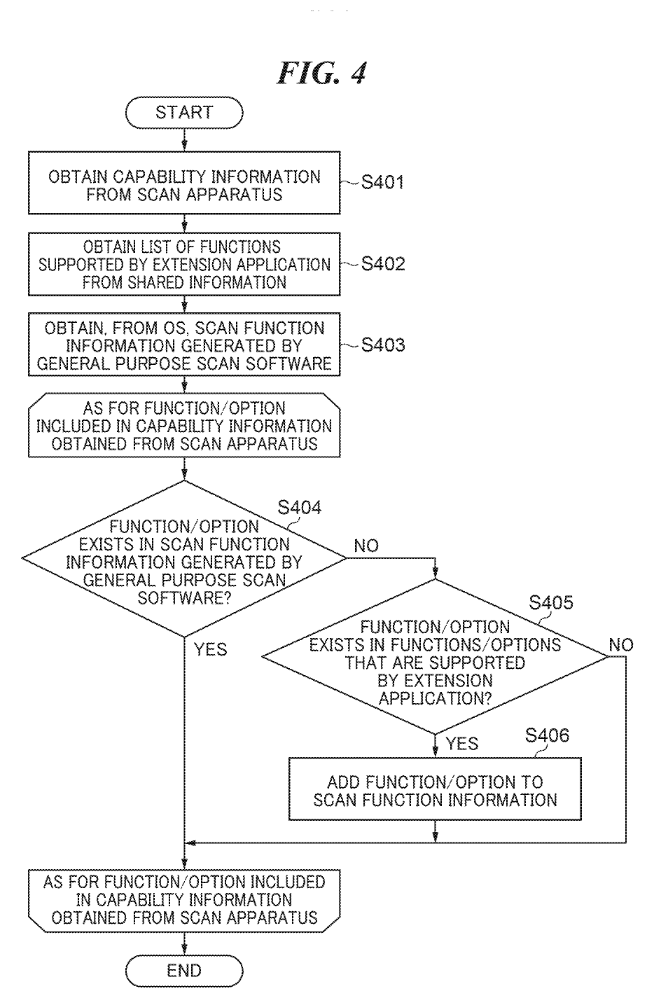

FIG. 4 is a flowchart that illustrates the procedure of an editing processing of the scan function information 203, which is executed by the scan function extending unit 206 shown in FIG. 2B. It should be noted that the editing processing of the scan function information 203 is realized by the CPU 111 executing the programs of the respective units that have been loaded from the external storage device 114 into the RAM 113.

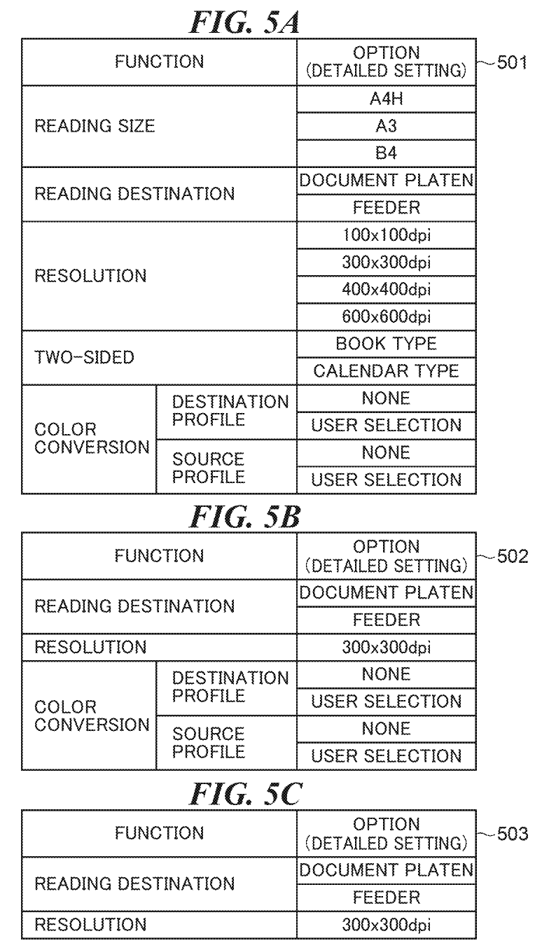

As shown in FIG. 4, first, in S401, the scan function extending unit 206 obtains capability information from the scan apparatus 102. This capability information includes attribute information indicating the functions that are capable of being designated in the scan apparatus 102, and setting values related to the attribute information. FIG. 5A is a diagram that illustrates an example of capability information 501 that has been obtained from the scan apparatus 102. As shown in FIG. 5A, the scan function extending unit 206 is capable of obtaining, from the scan apparatus 102, information about functions such as a reading size designation, and information about options that are capable of being set for each of the functions.

Next, in S402, the scan function extending unit 206 obtains, from the shared information 208, a list of scan functions supported by the extension application 204. The list of the scan functions supported by the extension application 204 has been stored in the shared information 208, and includes all the scan functions that are capable of being processed by the extension application 204 and their setting values. FIG. 5B is a diagram that illustrates an example of a list 502 of the scan functions supported by the extension application 204. The list 502 of the scan functions supported by the extension application 204 may be updated by, for example, updating the extension application 204.

Next, in S403, the scan function extending unit 206 obtains the scan function information 203, which has been created by the general purpose scan software 202, from the OS. FIG. 5C is a diagram that illustrates an example of a list 503 of scan functions supported by the general purpose scan software 202. The scan function information 203 to be created by the general purpose scan software 202 is created by the general purpose scan software 202 based on the capability information 501 that has been obtained from the scan apparatus 102. Since the scan function information 203 to be created by the general purpose scan software 202 describes (includes) only scan functions that are supported by the general purpose scan software 202 from among the capability information 501 that has been obtained from the scan apparatus 102, the functions described (included) in the scan function information are limited. For example, the capability information 501 that has been obtained from the scan apparatus 102 includes the destination profile and the source profile that are required for the color conversion function based on the scanner model-specific characteristic difference. On the other hand, the general purpose scan software 202 does not support the color conversion function based on the scanner model-specific characteristic difference, and the scan function information 203 does not include (does not describe) the information about the color conversion function based on the scanner model-specific characteristic difference. The scan function extending unit 206 adds information about functions and options thereof to the scan function information 203, which enables the extension application 204 to compensate for insufficient functions of the general purpose scan software 202. In addition, the scan function extending unit 206 is also able to delete unnecessary information about functions and options thereof from the scan function information 203 created by the general purpose scan software 202.

The subsequent S404, S405, and S406 are processes that are repeatedly performed for each function indicated by the capability information 501 that has been obtained from the scan apparatus 102 in S401. In the present embodiment, the subsequent S404, S405, and S406 are processes that are repeatedly performed for 15 types included in the capability information 501, from “reading size: A4H” to “source profile: user selection”.

First, in S404, the scan function extending unit 206 determines whether or not the function/option being processed exists in the scan function information 203 that has been generated by the general purpose scan software 202. For example, in the case where the function/option being processed is “reading destination: document platen”, the function/option being processed exists in the list 503 of the scan functions supported by the general purpose scan software 202. In such a case, it is determined in S404 that the function/option being processed exists in the scan function information 203 that has been generated by the general purpose scan software 202. If this determination is made, the scan function extending unit 206 selects the next item from among the functions/options included in the capability information that has been obtained from the scan apparatus 102, and the editing processing of FIG. 4 returns to S404. It should be noted that in the case where the function/option being processed is the last item in the capability information that has been obtained from the scan apparatus 102, the editing processing of FIG. 4 ends.

On the other hand, in the case where the function/option being processed is, for example, “reading size: A4H”, the function/option being processed does not exist in the list 503 of the scan functions supported by the general purpose scan software 202. In such a case, it is determined in S404 that the function/option being processed does not exist in the scan function information 203 that has been generated by the general purpose scan software 202. If this determination is made, the editing processing of FIG. 4 proceeds to S405.

In S405, the scan function extending unit 206 determines whether or not the function/option being processed exists in the functions/options that are supported by the extension application 204. In the case of being determined that the function/option being processed does not exist in the functions/options that are supported by the extension application 204, as in the case where the result of the determination in S404 is YES, the editing processing of FIG. 4 returns to S404 or the editing processing of FIG. 4 ends.

On the other hand, in the case of being determined that the function/option being processed exists in the functions/options that are supported by the extension application 204, the editing processing of FIG. 4 proceeds to S406. In the present embodiment, for example, in the case where the function/option being processed is “color conversion: source profile: user selection”, the function/option being processed exists in the list 502 of the scan functions supported by the extension application 204. In such a case, it is determined that the function/option being processed exists in the functions/options that are supported by the extension application 204.

In S406, the scan function extending unit 206 adds, to the scan function information 203, the function/option being processed. After the process of S406, as in the case where the result of the determination in S404 is YES, the editing processing of FIG. 4 returns to S404 or the editing processing of FIG. 4 ends.

In this way, the scan function extending unit 206 adds, to the scan function information 203, the function/option that is not supported by the general purpose scan software 202 but is supported by the scan apparatus 102 and the extension application 204. The scanning capabilities are generated based on the scan function information 203 that has been edited by the editing processing of FIG. 4 that has been described above. Furthermore, the scan setting screen extending unit 205 is able to generate a display screen based on the generated scanning capabilities, thereby extending the function that is not supported by the general purpose scan software 202, and displaying the detailed setting screen shown in FIG. 3C.

Next, a sequence of processes executed between the scan application 201, the general purpose scan software 202, the extension application 204, and the scan apparatus 102 after the scan application 201 accepts a scan setting will be described.

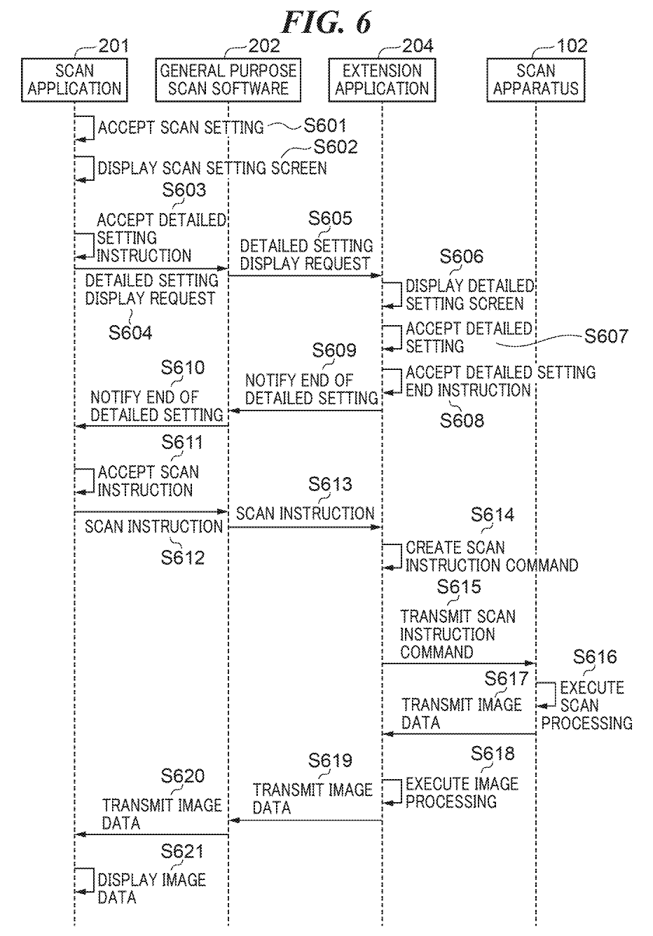

FIG. 6 is a sequence diagram that illustrates the procedure of a scan control processing executed in the scan system 100 shown in FIG. 1. It should be noted that respective steps in FIG. 6 other than respective steps (S616 and S617) executed by the scan apparatus 102 are realized by the CPU 111 loading the program of the scan application 201, the program of the general purpose scan software 202, and the program of the extension application 204 from the external storage device 114 into the RAM 113 and executing them. In addition, the respective steps (S616 and S617) executed by the scan apparatus 102 are realized by the CPU 191 of the scan apparatus 102 loading the program, which has been stored in the ROM 192 or the external storage device 199, into the RAM 193 and executing it.

As shown in FIG. 6, first, in S601, the scan application 201 accepts a scan setting from the user. The user is able to operate the pointing device 117 and/or the keyboard 118 to instruct the scan application 201 to accept the scan setting.

Next, in S602, the scan application 201 displays the scan setting screen shown in FIG. 3A on the display unit 119.

Next, in S603, the scan application 201 accepts a detailed setting instruction from the user. The user is able to issue a detailed setting instruction by operating the pointing device 117 or the keyboard 118 to select the control 302 on the scan setting screen shown in FIG. 3A.

Next, in S604, the scan application 201 makes a detailed setting display request with respect to the general purpose scan software 202.

Next, in S605, the general purpose scan software 202 makes the detailed setting display request with respect to the extension application 204. It should be noted that, as described above, in the case of the configuration in which the extension application 204 has been installed on the host computer 101 (the configuration shown in FIG. 2B), in response to this detailed setting display request, the detailed setting screen shown in FIG. 3C will be displayed.

Next, in S606, the scan setting screen extending unit 205 of the extension application 204 causes the display unit 119 to display the detailed setting screen shown in FIG. 3C. This is because, as described with reference to FIG. 4, the color conversion setting has been added to the scan function information 203 by the scan function extending unit 206. The scan setting screen extending unit 205 refers to the scanning capabilities generated based on the scan function information 203 to which the color conversion setting has been added, and causes the display unit 119 to display the detailed setting screen shown in FIG. 3C. In the present embodiment, since the extension application 204 supports one type of resolution, 300 × 300 dpi, there is no need for the user to select the one type of resolution, and an item for the one type of resolution is not displayed on the detailed setting screen. Even if an item is not selectable, the item that is not selectable may be displayed on the detailed setting screen to clearly inform the user.

Next, in S607, the scan setting screen extending unit 205 accepts a detailed setting. In the present embodiment, as shown in FIG. 3C, it is assumed that “reading destination: document platen”, “destination profile: Scan RGB_Plain Paper”, and “source profile: Monitor RGB 1” have been selected by the user. The setting values that have been set on the detailed setting screen shown in FIG. 3C are stored in the RAM 113 by the CPU 111.

Next, in S608, the scan setting screen extending unit 205 accepts an instruction to end the detailed setting (a detailed setting end instruction) from the user. The user is able to operate the pointing device 117 or the keyboard 118 to select the control 306 to issue the detailed setting end instruction. The extension application 204 writes the setting values that have been set on the detailed setting screen shown in FIG. 3C into the scan setting information. It should be noted that in the case of writing into the scan setting information, the extension application 204 may be configured to also write the item that has not been selected by the user, such as the resolution, into the scan setting information together.

Next, in S609, the extension application 204 notifies the general purpose scan software 202 that the detailed setting has been completed.

Next, in S610, the general purpose scan software 202 notifies the scan application 201 that the detailed setting has been completed. Upon receiving this notification, the scan application 201 displays the scan setting screen shown in FIG. 3A on the display unit 119.

Next, in S611, the scan application 201 accepts a scan instruction from the user. The user is able to operate the pointing device 117 or the keyboard 118 to select the control 303 to issue the scan instruction.

Next, in S612, the scan application 201 issues the scan instruction to the general purpose scan software 202.

Next, in S613, the general purpose scan software 202 issues the scan instruction to the extension application 204.

Next, in S614, the extension application 204 creates a scan instruction command based on the scan setting information that has been written in S608. It should be noted that this scan instruction command does not include setting values related to the color conversion setting that is not supported by the general purpose scan software 202 but is supported by the extension application 204 and the scan apparatus 102. In the case where the item that has not been selected by the user such as the resolution has not been written into the scan setting information in S608, the extension application 204 may be configured to add the item that has not been selected by the user such as the resolution to the scan instruction command when creating the scan instruction command in S614. In addition, a configuration may be adopted in which the item that has not been selected by the user such as the resolution is caused to operate as the default value of the scan apparatus 102 without adding the item that has not been selected by the user such as the resolution to the scan instruction command.

Next, in S615, the extension application 204 transmits the scan instruction command to the scan apparatus 102 to issue the scan instruction to the scan apparatus 102.

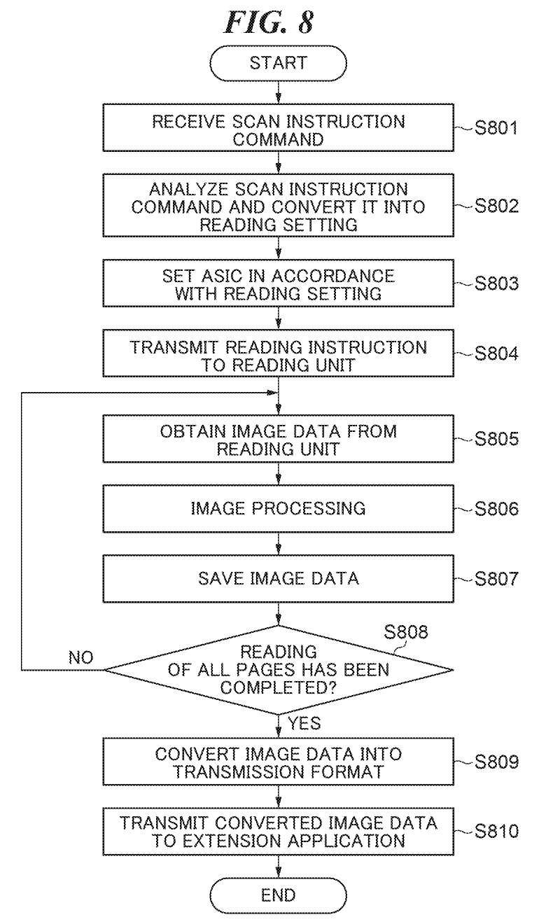

Next, in S616, the scan apparatus 102 executes a scan processing shown in FIG. 8, which will be described below.

Next, in S617, the scan apparatus 102 transmits the generated image data to the extension application 204.

Next, in S618, the extension application 204 performs necessary image processing in accordance with the scan instruction, with respect to the received image data. Specifically, the extension application 204 reads out the ICC profiles corresponding to the scan instruction from the external storage device 114 and executes the color conversion method using the ICC profiles, which has been described with reference to FIG. 9B, with respect to the image data that has been received from the scan apparatus 102. For example, in the case where the color conversion setting shown in FIG. 3C has been performed, a first color conversion processing using the destination profile of “Scan RGB_Plain Paper” is performed with respect to the received image data. Furthermore, with respect to the image data that has been subjected to the first color conversion processing, a second color conversion processing using the source profile of “Monitor RGB 1” is performed. In this way, processed image data is generated. By performing such color conversion processing, image data is generated in which the color tones of the document and the color tones on the monitor are closer to each other than when the color conversion processing is not performed.

Next, in S619, the extension application 204 transmits the processed image data to the general purpose scan software 202.

Next, in S620, the general purpose scan software 202 transmits, to the scan application 201, the image data that has been obtained from the extension application 204.

Next, in S621, the scan application 201 displays, on the display unit 119, the image data that has been obtained from the general purpose scan software 202. Thereafter, the scan control processing shown in FIG. 6 ends.

Next, in the scan control processing shown in FIG. 6 that has been described above, a scan instruction command generation processing executed by the extension application 204 will be described. The scan instruction command generation processing includes the above-described processes of S606, S607, S608, S614, S615, S618, and S619.

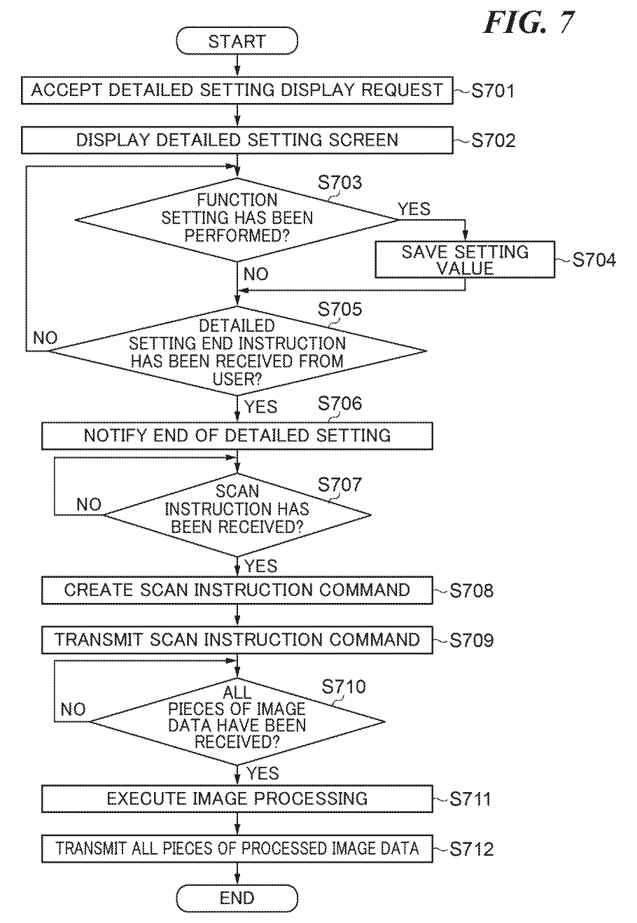

FIG. 7 is a flowchart that illustrates the procedure of the scan instruction command generation processing executed by the extension application 204 shown in FIG. 2B. It should be noted that respective steps are realized by the CPU 111 executing the programs of the respective units that have been loaded from the external storage device 114 into the RAM 113.

As shown in FIG. 7, first, in S701, the extension application 204 accepts the detailed setting display request from the general purpose scan software 202.

Next, in S702, the scan setting screen extending unit 205 of the extension application 204 causes the display unit 119 to display the detailed setting screen shown in FIG. 3C (for example, see S606 described above). This is because, as described with reference to FIG. 4, the color conversion setting has been added to the scan function information by the scan function extending unit 206. The scan setting screen extending unit 205 refers to the scanning capabilities generated based on the scan function information to which the color conversion setting has been added, and causes the display unit 119 to display the detailed setting screen shown in FIG. 3C.

Next, in S703, the scan setting screen extending unit 205 determines whether or not a function setting on the detailed setting screen has been performed by the user. In the case of being determined in S703 that a function setting on the detailed setting screen has been performed by the user, the scan instruction command generation processing shown in FIG. 7 proceeds to S704. In S704, the CPU 111 saves (stores), in the RAM 113, the setting values that have been set on the detailed setting screen. Next, the scan instruction command generation processing shown in FIG. 7 proceeds to S705.

In the case of being determined in S703 that a function setting on the detailed setting screen has not been performed by the user, the scan instruction command generation processing shown in FIG. 7 proceeds to S705. In S705, the scan setting screen extending unit 205 determines whether or not a detailed setting end instruction has been received from the user. In the case of being determined in S705 that a detailed setting end instruction has not been received from the user, the scan instruction command generation processing shown in FIG. 7 returns to S703. In the case of being determined in S705 that a detailed setting end instruction has been received from the user (for example, see S608 described above), the extension application 204 writes the setting values that have been set on the detailed setting screen into the scan setting information.

Next, in S706, the extension application 204 notifies the general purpose scan software 202 that the detailed setting has been completed (for example, see S609 described above).

Next, in S707, the extension application 204 determines whether or not a scan instruction has been received from the general purpose scan software 202. The extension application 204 waits until a scan instruction is received from the general purpose scan software 202. When a scan instruction is received from the general purpose scan software 202 (YES in S707), the scan instruction command generation processing shown in FIG. 7 proceeds to S708.

In S708, the extension application 204 creates a scan instruction command based on the scan setting information into which the setting values that have been set on the detailed setting screen are written (for example, see S614 described above). It should be noted that this scan instruction command does not include the setting values related to the color conversion setting that is not supported by the general purpose scan software 202 but is supported by the extension application 204 and the scan apparatus 102.

Next, in S709, the extension application 204 transmits the scan instruction command to the scan apparatus 102 (for example, see S615 described above).

Next, in S710, the extension application 204 determines whether or not all pieces of the image data have been received from the scan apparatus 102. The extension application 204 waits until all pieces of the image data have been received from the scan apparatus 102. When all pieces of the image data have been received from the scan apparatus 102 (YES in S710), the scan instruction command generation processing shown in FIG. 7 proceeds to S711.

In S711, the extension application 204 performs necessary image processing in accordance with the scan instruction, with respect to the received image data (for example, see S618 described above). Specifically, the extension application 204 reads out the ICC profiles corresponding to the scan instruction from the external storage device 114 and executes the color conversion method using the ICC profiles, which has been described with reference to FIG. 9B, with respect to the image data that has been received from the scan apparatus 102.

Next, in S712, the extension application 204 transmits the processed image data to the general purpose scan software 202 (for example, see S619 described above). Thereafter, the scan instruction command generation processing shown in FIG. 7 ends.

Next, the scan processing in S616 performed by the scan apparatus 102 in the scan control processing shown in FIG. 6 that has been described above will be described.

FIG. 8 is a flowchart that illustrates the procedure of the scan processing performed in S616 of FIG. 6. It should be noted that respective operations (respective steps) shown in the flowchart of FIG. 8 are realized by the CPU 191 executing the program that has been stored in the RAM 192.

As shown in FIG. 8, first, in S801, the CPU 191 receives the scan instruction command that has been transmitted from the extension application 204.

Next, in S802, the CPU 191 analyzes the scan instruction command that has been received in S801, and converts it into a reading setting to be used in a reading processing by the scan apparatus 102. In the present embodiment, as an example, it is assumed to have been converted into a reading setting for performing the reading processing with “document platen” and “resolution: 300 × 300 dpi”.

Next, in S803, the CPU 191 decides an application specific integrated circuit (an ASIC) of the image processing unit 190 to be used for executing scanning based on the reading setting that has been converted in S802, and performs the setting of the decided ASIC.

Next, in S804, the CPU 191 transmits, to the reading unit 195, a reading instruction corresponding to the reading setting. The reading unit 195 performs a reading operation in accordance with this reading instruction.

Next, in S805, the CPU 191 obtains the image data from the reading unit 195.

Next, in S806, the CPU 191 and the image processing unit 190 execute an image processing with respect to the obtained image data. In the present embodiment, for example, an image processing of converting the resolution of the obtained image data into “300 × 300 dpi” is performed. It should be noted that if the reading unit 195 is capable of performing reading at “300 × 300 dpi”, a configuration may be adopted in which the reading unit 195 obtains the image data at “300 × 300 dpi” and the image processing of converting the resolution into “300 × 300 dpi” is not performed in S806.

Next, in S807, the CPU 191 saves the image data in the external storage device 199.

Next, in S808, the CPU 191 determines whether or not reading of all pages has been completed. In the case of being determined in S808 that reading of any page has not been completed, the scan processing shown in FIG. 8 returns to S805. On the other hand, in the case of being determined in S808 that reading of all pages has been completed, the scan processing shown in FIG. 8 proceeds to S809.

In S809, the CPU 191 and the image processing unit 190 convert the image data that has been saved in S807, in accordance with the setting of a transmission format included in the scan instruction command that has been received in S801. In the present embodiment, the transmission format is not included in the scan instruction command that has been accepted from the extension application 204. Therefore, although the image data that has been saved in S807 is converted into JPEG format, which is the default format of the scan apparatus 102, the transmission format, into which the image data is converted, is not limited to the JPEG format and may be any format so long as it is a format that is capable of being handled by the information processing apparatus.

Next, in S810, the CPU 191 transmits, to the extension application 204, the image data that has been converted. Thereafter, the scan processing shown in FIG. 8 ends.

As described above, in the present embodiment, the scan setting screen extending unit 205 of the extension application 204 modifies the scan function information 203 based on the capability information of the general purpose scan software 202, the extension application 204, and the scan apparatus 102. Furthermore, when the user requests a detailed setting screen, the detailed setting screen shown in FIG. 3C is capable of being displayed based on the scanning capabilities that have been generated based on the scan function information 203, allowing the user to perform the setting of the color conversion. Thereafter, the extension application 204 executes the color conversion processing based on the color conversion setting, with respect to the image data that has been obtained from the scan apparatus 102. The above series of processes allows the user to use the color conversion function.

It should be noted that in the present embodiment, the configuration in which the detailed setting screen shown in FIG. 3C is displayed under the configuration shown in FIG. 2B has been described, but the present disclosure is not limited to this configuration. For example, in the case where a detailed setting display request is made with respect to the general purpose scan software 202 in S604, the general purpose scan software 202 may display, on the display unit 119, the detailed setting screen shown in FIG. 3B. Then, after a detailed setting on the detailed setting screen shown in FIG. 3B is completed, the general purpose scan software 202 requests the extension application 204 to display an additional detailed setting screen. Next, the extension application 204 may cause to additionally display a detailed setting screen on which the color conversion setting is capable of being performed.

In addition, in the embodiment described above, although the configuration has been described in which the scan instruction to the extension application 204 is issued from the general purpose scan software 202, the present disclosure is not limited to this configuration. For example, a configuration may be adopted in which a scan instruction is issued from the scan application 201 to the extension application 204, or a configuration may be adopted in which a control for issuing a scan instruction is arranged on the detailed setting screen and the user issues an instruction directly to the extension application 204 by using this control. In addition, the image data may be transferred directly from the extension application 204 to the scan application 201 without going through the general purpose scan software 202, or the image data may be transferred from the scan apparatus102 to the scan application 201. In addition, a configuration may be adopted in which the received image data is saved (stored) in the external storage device 114 and only information about a file path that is a storage destination of the received image data is transferred.

In addition, in the present embodiment, in the case where there are a plurality of pieces of the image data, although the configuration has been described in which all the plurality of pieces of the image data are received and then transferred, a configuration may be adopted in which one of the plurality of pieces of the image data is transferred whenever the one of the plurality of pieces of the image data is received.

In the present embodiment, a configuration may be adopted in which ICC profile(s) that has/have not been stored in the external storage device 114 is/are capable of being newly registered. It should be noted that the ICC profile that has not been stored in the external storage device 114 basically only needs to satisfy the format defined by the ICC profile, and an ICC profile created by the user himself/herself or the like also becomes the target of the ICC profile that has not been stored in the external storage device 114. In the configuration in which the ICC profile(s) that has/have not been stored in the external storage device 114 is/are capable of being newly registered, the configuration of a detailed setting screen is partially different from the configuration of the detailed setting screen shown in FIG. 3C described above. The following describes the difference from the configuration of the detailed setting screen shown in FIG. 3C described above.

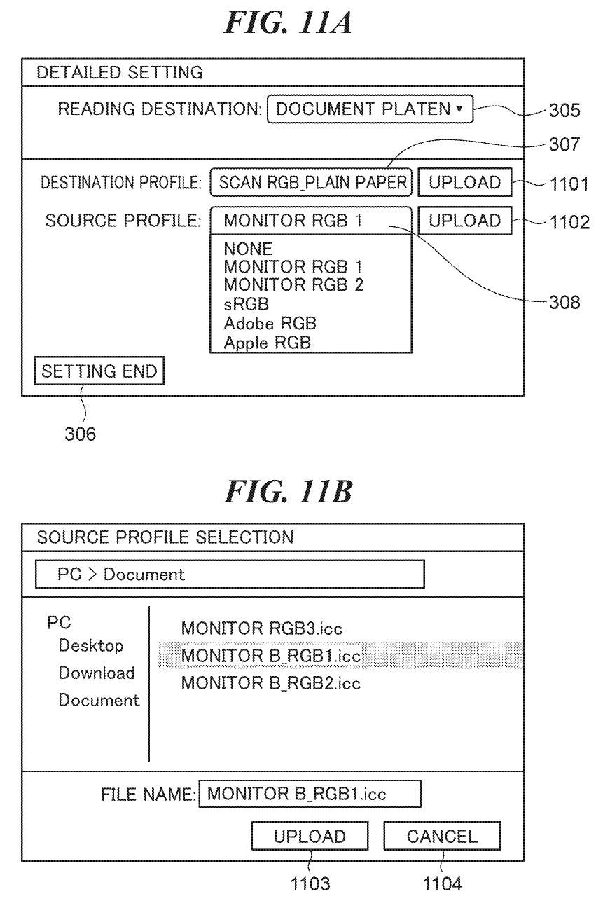

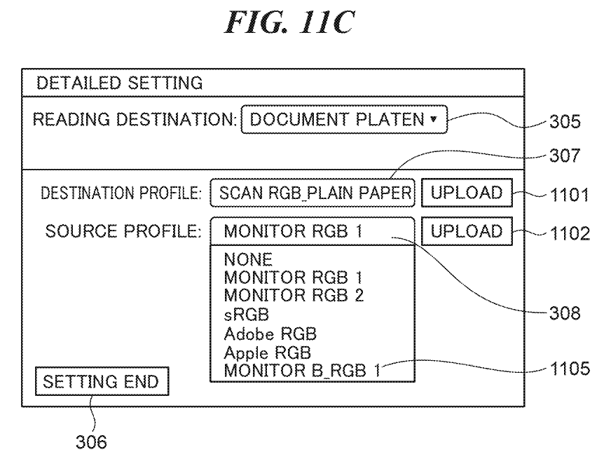

FIG. 11A is a diagram that illustrates an example of a detailed setting screen displayed by the scan setting screen extending unit 205. The difference from the detailed setting screen shown in FIG. 3C described above is that the detailed setting screen shown in FIG. 11A includes an upload button 1101 corresponding to the destination profile and an upload button 1102 corresponding to the source profile. For example, in the case where the user wants to use an ICC profile other than the ICC profiles displayed in the pull-down 307 for selecting a destination profile or an ICC profile other than the ICC profiles displayed in the pull-down 308 for selecting a source profile, the user presses the corresponding upload button.

FIG. 11B is a diagram that illustrates an example of a source profile selection screen that is displayed when the upload button 1102 corresponding to the source profile is pressed. Here, as an example, hierarchical directories and files in the file system of the OS are displayed. First, the user selects, on this source profile selection screen, an ICC profile that he or she wants to upload. In FIG. 11B, an ICC profile called “Monitor B_RGB1.icc” has been selected. Thereafter, when the user presses an upload button 1103 on the source profile selection screen, the selected “Monitor B_RGB1.icc” is imported into the host computer 101. Specifically, for example, if there is a directory in which source profiles are collected in the external storage device 114 as described above, the selected ICC profile is copied into the directory. It should be noted that by pressing a cancel button 1104, the upload of the ICC profile is canceled.

FIG. 11C is a diagram that illustrates an example of a detailed setting screen that is transitioned after the upload button 1103 is pressed. The difference from the detailed setting screen shown in FIG. 11A is that on the detailed setting screen shown in FIG. 11C, “Monitor B_RGB 1” 1105 uploaded in FIG. 11B has been added to the pull-down 308 for selecting a source profile. In addition, in FIG. 11C, the uploaded ICC profile has been automatically selected in the pull-down 308.

As described above, in the present embodiment, it is possible to newly register ICC profile(s) prepared by the user. As a result, it is possible to realize the color conversion using ICC profile(s) other than the ICC profiles that have been stored in the external storage device 114 in advance.

In addition, in the present embodiment, a configuration may be adopted in which a preview for confirming (checking) the color tones according to the ICC profiles that have been selected on the detailed setting screen is displayed. It should be noted that in the embodiment described above, the user is not able to confirm (check) the color tones according to the selected ICC profiles until the image data that has been subjected to the color conversion processing is actually displayed on the display unit 119. Therefore, if the color tones of the displayed image data are not the intended color tones, it is necessary to select the ICC profiles again and perform scanning again, which is time-consuming.

In order to deal with this issue, in the present embodiment, at a stage where ICC profiles have been selected on the detailed setting screen, a preview, which allows the user to confirm (check) the color tones according to the selected ICC profiles, is displayed. In such a configuration, the configuration of a detailed setting screen is partially different from the configuration of the detailed setting screen shown in FIG. 3C described above. The following describes the difference from the configuration of the detailed setting screen shown in FIG. 3C described above.

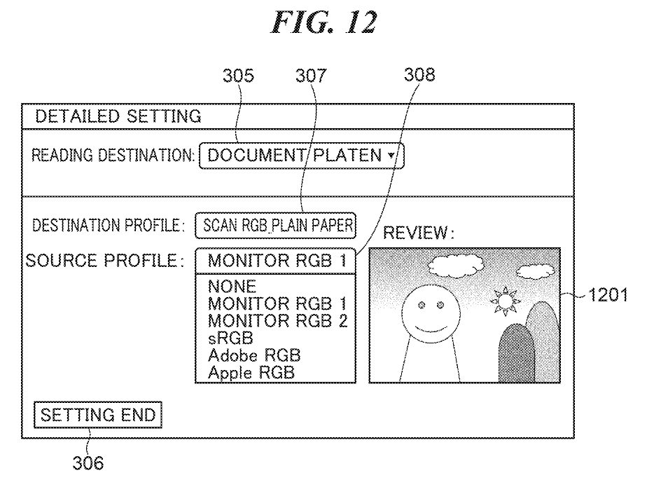

FIG. 12 is a diagram that illustrates an example of a detailed setting screen displayed by the scan setting screen extending unit 205. The difference from the detailed setting screen shown in FIG. 3C described above is that the detailed setting screen shown in FIG. 12 includes a preview image 1201. A method for displaying the preview image 1201 will be described below.

After transitioning to the detailed setting screen shown in FIG. 12, first, the scan apparatus 102 executes scanning to generate image data in the RGB color space of the scanner (for example, the image 902 shown in FIG. 9B). The generated image data is transmitted to the host computer 101 and is retained (stored) in the RAM 113 or the like of the host computer 101. Next, the extension application 204 of the host computer 101 performs a first color conversion processing using the currently selected destination profile, with respect to the obtained image data. Then, with respect to the image data that has been subjected to the first color conversion processing, a second color conversion processing using the source profile is performed. As a result, an RGB image that has been subjected to the second color conversion processing (for example, the image 912 shown in FIG. 9B) is obtained. This RGB image is displayed as the preview image 1201 on the detailed setting screen.

In addition, the display of a preview image in the case of being switched to a different ICC profile by using the pull-down 307 or the pull-down 308 will be described. As described above, after transitioning to the detailed setting screen, the host computer 101 has already retained, in the RAM 113, the image 902 in the RGB color space of the scanner that is to be used to display the preview image. Therefore, a preview image is generated by performing a color conversion using the ICC profile that has been changed by the pull-down 307 or the pull-down 308, with respect to the image 902 in the RGB color space of the scanner that has been retained in the RAM 113.

As described above, in the present embodiment, the preview image 1201 for confirming (checking) the color tones according to the ICC profiles that have been selected on the detailed setting screen is displayed. As a result, at a timing when the user selects an ICC profile on the detailed setting screen, the user is able to immediately confirm (check) the color tones according to the selected ICC profile.

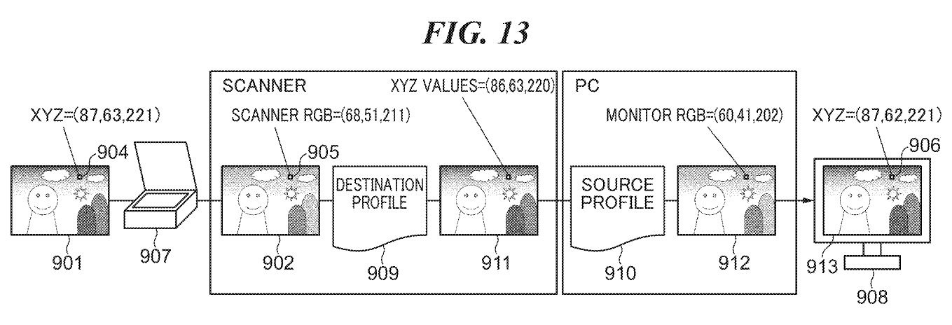

In addition, in the embodiment described above, although the configuration has been described in which the extension application 204 of the host computer 101 performs both the first color conversion processing and the second color conversion processing, the present disclosure is not limited to this configuration. For example, a configuration may be adopted in which the scan apparatus 102 performs at least one of the first color conversion processing and the second color conversion processing. For example, as shown in FIG. 13, a configuration may be adopted in which the scan apparatus 102 performs the first color conversion processing using the destination profile, and the extension application 204 of the host computer 101 performs the second color conversion processing using the source profile. In such a configuration, for example, in S615 of FIG. 6, the extension application 204 transmits, to the scan apparatus 102, a scan instruction command including information about a destination profile that has been selected by the pull-down 307 on the detailed setting screen shown in FIG. 3C. It should be noted that as a method for creating a scan instruction command, there is a method for extending a command of a standard protocol (a command conforming to the standard protocol). For example, there is a method of describing a dedicated command in an extension area of a command of the standard protocol. In addition, other methods include a method of adding a command of a unique standard (a command conforming to the unique standard) to the end of a command of the standard protocol, and a method in which the extension application 204 overwrites a command of the standard protocol with a unique command system. In addition, in the case of issuing an instruction from the extension application 204, the instruction and communication may be performed according to a vendor's unique protocol, regardless of the standard protocol. Next, in S616, the scan apparatus 102 executes a scan processing in accordance with the received scan instruction command. Then, the scan apparatus 102 performs a color conversion processing using the destination profile indicated by the scan instruction command (the first color conversion processing), with respect to the image data that has been generated by the reading unit 195. It should be noted that the destination profile has been stored in advance in the ROM 192 or the like. In addition, in S616, the scan apparatus 102 transmits, to the host computer 101, the image data that has been subjected to the first color conversion processing. In S617, the extension application 204 of the host computer 101 performs a color conversion processing using the source profile that has been selected by the pull-down 308 on the detailed setting screen shown in FIG. 3C (the second color conversion processing), with respect to the received image data that has been subjected to the first color conversion processing.

Also with this configuration, it is possible to achieve the same effects as those of the embodiment described above.

According to the present disclosure, it is possible to allow the user to use the color conversion function based on the scanner model-specific characteristic difference.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063059, filed Apr. 7, 2025, which is hereby incorporated by reference herein in its entirety.

What is claimed is:

1. A non-transitory computer-readable storage medium storing a program that extends functions of general purpose scan software capable of being used in common for reading apparatuses provided by a plurality of manufacturers, the program causing an information processing apparatus to perform
a step of causing a display unit of the information processing apparatus to display a display screen that accepts a setting for a color conversion processing based on a scanner model-specific characteristic difference, with respect to a read image that has been generated by a designated reading apparatus; and
a step of causing the information processing apparatus to execute the color conversion processing with respect to the read image that has been generated by the reading apparatus, based on the setting that has been accepted on the display screen.

2. The non-transitory computer-readable storage medium according to claim 1, wherein
the display screen includes objects for selecting ICC profiles to be used in the color conversion processing, and a preview image for confirming color tones according to the ICC profiles that have been selected by the objects, of the read image.

3. The non-transitory computer-readable storage medium according to claim 2, wherein
the display screen further includes an object for uploading an ICC profile other than ICC profiles selectable by the objects.

4. The non-transitory computer-readable storage medium according to claim 2, wherein
the ICC profiles include a first ICC profile for converting from a color space dependent on the reading apparatus into a device-independent absolute color space, and a second ICC profile for converting from the device-independent absolute color space into a color space dependent on the display unit of the information processing apparatus.

5. The non-transitory computer-readable storage medium according to claim 4, wherein
the step of causing the information processing apparatus to execute the color conversion processing causes the information processing apparatus to execute both a first color conversion processing using the first ICC profile designated on the display screen and a second color conversion processing using the second ICC profile designated on the display screen, with respect to the read image that has been generated by the reading apparatus.

6. The non-transitory computer-readable storage medium according to claim 4, wherein
the software code is adapted to further perform a step of causing the reading apparatus to execute a first color conversion processing using the first ICC profile designated on the display screen with respect to the read image that has been generated by the reading apparatus, and
the step of causing the information processing apparatus to execute a second color conversion processing using the second ICC profile designated on the display screen with respect to image data that has been obtained from the reading apparatus and has been subjected to the first color conversion processing.

7. An information processing apparatus comprising general purpose scan software capable of being used in common for reading apparatuses provided by a plurality of manufacturers and a program that extends functions of the general purpose scan software, the information processing apparatus comprising:
at least one processor; and
a memory coupled to the processor storing the program that, when executed by the processor, causes the processor to:
display a display screen that accepts a setting for a color conversion processing based on a scanner model-specific characteristic difference, with respect to a read image that has been generated by a designated reading apparatus; and
execute the color conversion processing with respect to the read image that has been generated by the reading apparatus, based on the setting that has been accepted on the display screen.

8. A control method for an information processing apparatus comprising general purpose scan software capable of being used in common for reading apparatuses provided by a plurality of manufacturers and a program that extends functions of the general purpose scan software, the control method comprising:
displaying a display screen that accepts a setting for a color conversion processing based on a scanner model-specific characteristic difference, with respect to a read image that has been generated by a designated reading apparatus; and
executing the color conversion processing with respect to the read image that has been generated by the reading apparatus, based on the setting that has been accepted on the display screen.
